(19) United States
(12) Patent Application Publication
(10) Pub. No.: US 2010/0098089 A1
(43) Pub. Date: Apr. 22, 2010

(54) PACKET TRANSFER DEVICE AND METHOD

(75) Inventor: Hiroyuki MAKINO, Kawasaki (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/491,960

(22) Filed: Jun. 25, 2009

(30) Foreign Application Priority Data
Oct. 20, 2008 (JP) 2008-269316

(51) Int. Cl. H04L 12/56

(52) U.S. Cl. 370/395.31

(57) ABSTRACT

Conventional Packet transfer technology relaying data through the network system needs to designate a relay communication line designated by the network system, together with relaying while taking into account the degree of importance or degree of priority of a packet. Accordingly, there is implemented, in a network system having a plurality of quality levels or communication lines, a device capable of dynamically controlling packet transfers in response to the quality or the state of the communication lines. The packet transfer device possesses a first table in which events that may occur on the occasion of transmission and reception processing are defined and a second table in which the processing executed in case the concerned defined event occurs is defined and, in case a defined event occurs, the second table is looked up and the packet transfer routes of the routing table are modified dynamically.

### INCORPORATION BY REFERENCE

The present application claims priority from Japanese application JP 2008-269316 filed on Oct. 20, 2008, the content of which is hereby incorporated by reference into this application.

### BACKGROUND OF THE INVENTION

1. Field of the Invention

The present invention pertains to a packet transfer device and method associated with a computer network system relaying data packets.

2. Description of the Related Art

In recent years, due to the growth of networks such as the Internet and NGN (New Generation Network), data pertaining to various services, such as VoIP (Voice Over Internet Protocol) for carrying out voice communication via IP networks and IPTV (Internet Protocol Television) carrying out delivery of TV programs via IP networks, have come to be handled over networks.

In conventional computer network systems, regarding packet transfer technology relaying data via a computer network system, it has been difficult to designate, together with relaying while taking into consideration e.g. the degree of importance or the degree of priority of the packets for each service, the relay line designated by the computer network system.

On the occasion of this type of problems, there was proposed, in JP-A-5-160857, a method of identifying the terminal (subscriber) and conferring a degree of priority corresponding to the terminal. Also, in JP-A-5-191455, there is proposed a method of selecting a single relay line in accordance with the degree of priority or the degree of importance of the packets.

### SUMMARY OF THE INVENTION

In the conventional methods, problems such as those indicated below can be considered.

First, in the case where a plurality of packets having differing degrees of priority or degrees of importance are transmitted to one and the same terminal or network, it is possible to control the sequential order of transmission in the packet transfer device. However, it has been taken to be difficult to transmit packets with a high degree of priority or degree of importance by selecting a high-quality or high-speed line or, on the contrary, to transmit packets having a low degree of priority or degree of importance by selecting a low-quality or low-speed line. Also, it has been taken to be difficult to use a plurality of relay lines transmitting packets and determine a ratio in the allocation of communication lines transmitting packets, in correspondence with the degree of priority or degree of importance.

In order to solve the aforementioned problems, the present invention is characterized in that it is possible, regarding packets having differing degrees of priority or degrees of importance and which are to be transmitted to the same terminal or network, to arbitrarily designate in a packet relay device the relay lines and the relay ratio for each degree of priority or degree of importance and to select one or several transmission lines in accordance with the characteristic of the packets.

According to the present invention, it is possible to arbitrarily select a packet transfer communication line in a packet relay device, in correspondence with the degree of priority or degree of importance of a packet and it is possible to transfer the packet in accordance with the quality and speed of the constituent network communication lines in the computer network system to which the concerned packet relay device is attached.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a computer network system.

FIG. 2 is an example of the internal configuration of a packet transfer device.

FIGS. 3A, 3B, and 3C are an example of a packet transfer table.

FIGS. 4A, 4B, and 4C are examples of an event table, an action table, and a command table, respectively.

FIG. 5 is an example of a flow indicating the operations of a packet transfer device at the time of packet transmission and reception.

FIG. 6 is an example of a flow indicating the operations of a packet transfer device at the time of event generation.

FIG. 7 is an example of the continuation of a flow indicating the operations of a packet transfer device at the time of event generation.

FIG. 8 is an example of a cooperative sequence of each functional part of a packet transfer device at the time of event generation.

FIGS. 9A and 9B are examples of transfer table command data and a new packet transfer table.

### DESCRIPTION OF THE EMBODIMENTS

Hereinafter, the embodiments will be described using the drawings.

The system of the present embodiment can be applied in a network managed by an ISP (Internet Service Provider). The system sets a degree of priority by service for the packets flowing in the network, selects a transfer destination device or a communication line to be used, in response to the same degree of priority, and ascertains the states of the communication lines, and carries out, in response to the state of the communication lines, modifications in the utilization rates of the transferring communication lines. E.g., information determining the packet quality is stored in the TOS (Type of Service) bit of the IP packet, such as the degree of priority of the IP packet, and by referring to the TOS, it is possible to ascertain the degree of priority of each of the packets by consulting the TOS. Alternatively, there may be independently stored data indicating the degree of priority of the packets, in the data storage part of each IP packet.

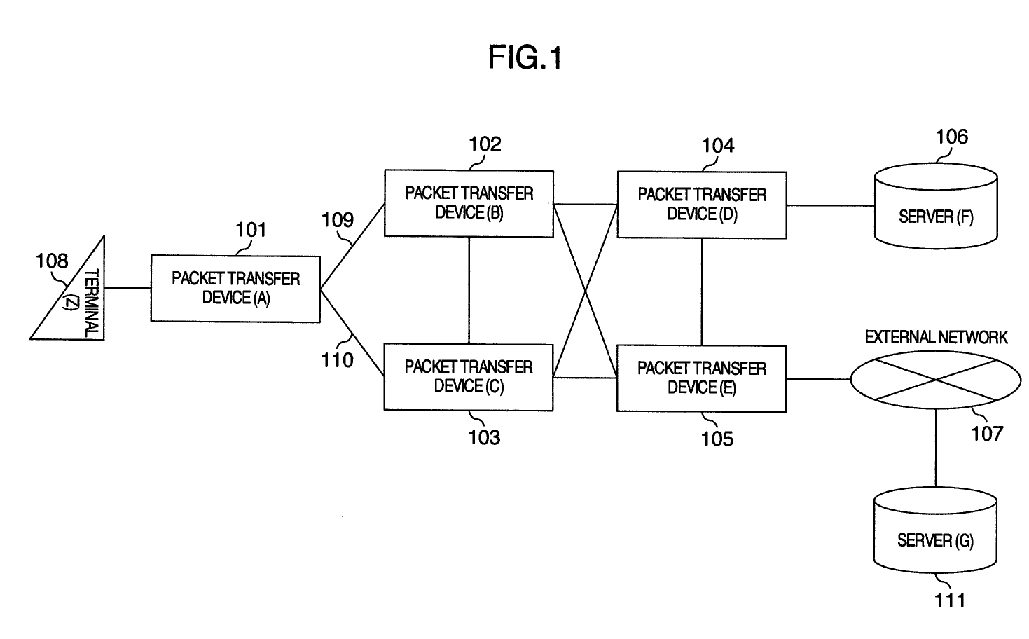

In FIG. 1, there is shown an example of a computer network system of the present embodiment, constituted by packet transfer devices. The concerned computer network system is composed of a packet transfer device 101, a packet transfer device 102, a packet transfer device 103, a packet transfer device 104, a packet transfer device 105, a server 106, an external network 107, a terminal 108, a server 111, and a communication line α109 and a communication line β110 which are connected with packet transfer device 101.

Here, communication line α109 is taken to be a high-speed and high-quality communication line and communication line β110 is taken to be a best-effort communication line. Also, as for each packet transfer device and the terminal, a packet transfer device 101 has A, a packet transfer device 102 has B, a packet transfer device 103 has C, a packet transfer device 104 has D, a packet transfer device 105 has E, a server 106 has F, a server 111 connected via external network 107 has G, and terminal 108 has Z, respectively, as its network address. Further, this being but an example of a packet transfer device network configuration and communication line classification, a configuration not restricted to FIG. 1 may also be acceptable. E.g., a configuration including a wireless network may be acceptable. Also, the present embodiment is taken to be an example using an IP (Internet Protocol) network, but another communication protocol may also be used.

The configuration of FIG. 1 indicates as an example a network managed by a certain ISP (Internet Service Provider). Terminal 108 is the terminal of a user subscribing to a connection service of the ISP. Packet transfer device 101 is a device terminating the connections from the terminal of each user and is located on the edge of the ISP network, i.e. at the entrance, seen from terminal 108, of the network managed by the ISP. Packet transfer devices 102 to 105 are devices carrying out packet routing in the network managed by the ISP and are present in the core network, i.e. in locations which cannot be directly connected, seen from 108.

As a working example, if packet transfer device 101 receives a packet from terminal 108, it judges, by means of the final destination and degree of priority of the received packet, whether to make packet transfer device 102 or packet transfer device 103 the transfer destination, or whether to make the transfer to both of them. Packet transfer device 101 further decides the packet transfer ratio by means of the final destination of the packet and the degree of priority, in the case of making a transfer to both packet transfer devices 102 and 103. E.g., packet transfer device 101 transfers 80 percent of the packets via communication line α109 to packet transfer device 102 and transfers 20 percent of the packets via communication line α110 to packet transfer device 103.

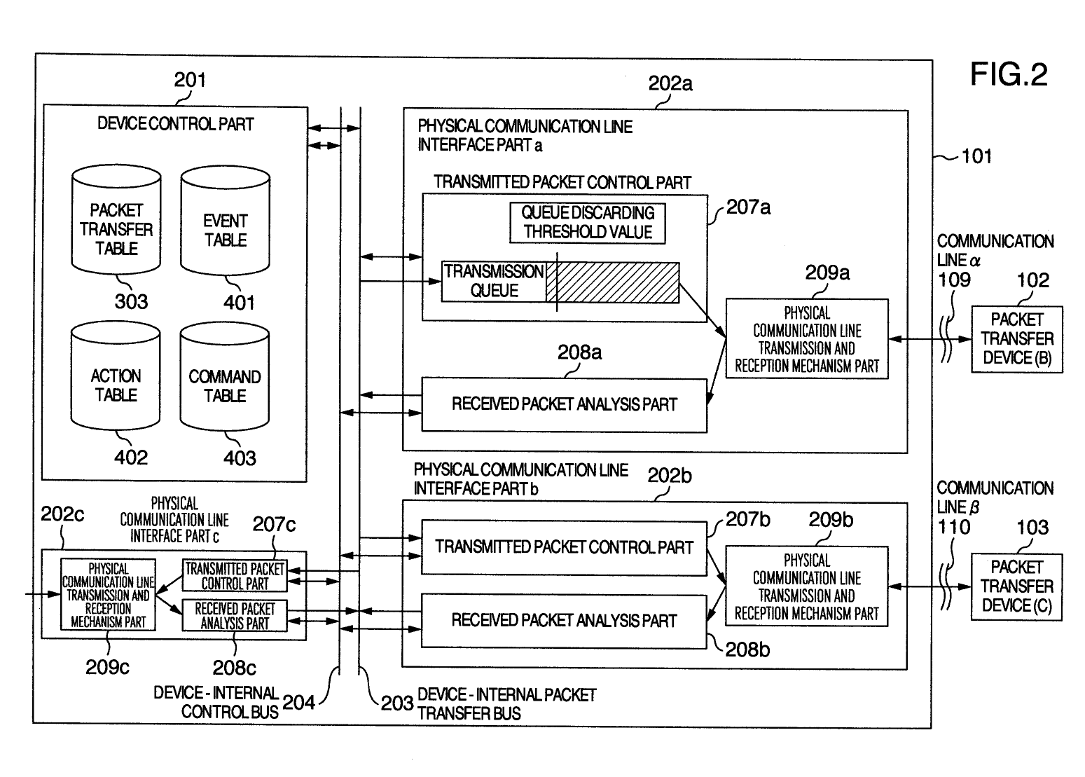

In FIG. 2, the configuration of packet transfer device 101 is shown. Packet transfer device 101 is composed of a device control part 201, a physical communication line interface part a 202a, a physical communication line interface part b 202b, a physical communication line interface part c 202c, a device-internal packet transfer bus 203, and a device-internal control bus 204.

Also, device control part 201 includes a packet transfer table 303, an event table 401, an action table 402, and a command table 403.

In addition, physical communication line interface part a202a includes a transmission packet control part 207a, a received packet analysis part 208a, and a physical communication line transmission and reception mechanism part 209a. Physical communication line interface part b202b includes a transmitted packet control part 207b, a received packet analysis part 208b, and a physical communication line transmission and reception mechanism part 209b. Physical communication line interface part c202c includes a transmitted packet control part 207c, a received packet analysis part 208c, and a physical communication line transmission and reception mechanism part 209c. Further, in the present drawing, it is assumed that there are three physical communication line interface parts, i.e. a packet transfer device a102a, a packet transfer device b102b, and a packet transfer device c102c, but four or more parts would also be acceptable. Also, regarding packet transfer devices 102 to 105, the configuration is the same. In addition, although not shown in the drawing, physical communication line interface part c202c is connected with terminal 108 of FIG. 1.

Device control part 201 controls, by means of the degree of priority of packets and the state of the communication lines, the packet transfer processing of packet transfer device 101. Device control part 201 looks up packet transfer table 303 and determines the transfer destination and the like of the packet. Also, device control part 201 monitors, in physical communication line interface part 202, the states of the communication lines connected with packet transfer device 101 and, in case the state of the monitored communication line corresponds to any of the events defined in event table 401, carries out an update processing of packet transfer table 303, using action table 402 and command table 403. A description will subsequently be given of the details of each table.

The physical line interface part a202a is an interface for transmitting and receiving packets. It carries out transmission processing by means of the transmitted packet control part 207a. The transmitted packet control part has a transmission queue internally, there being set a threshold value for discarding data if the data accumulate to or beyond a fixed level in the transmission queue. The received packet analysis part 208a analyzes the received packets and verifies that there is no anomaly such as errors in the packets. The physical communication line transmission and reception mechanism part 209a carries out transmission and reception of physical packets to and from the facing device. In the present embodiment, the physical communication line interface part a202a is an interface for exchanging data with the packet transfer device 102 via the communication line α109. The physical communication line interface part b202b and the physical communication line interface part c202c is the same configuration as the physical communication line interface part a202a.

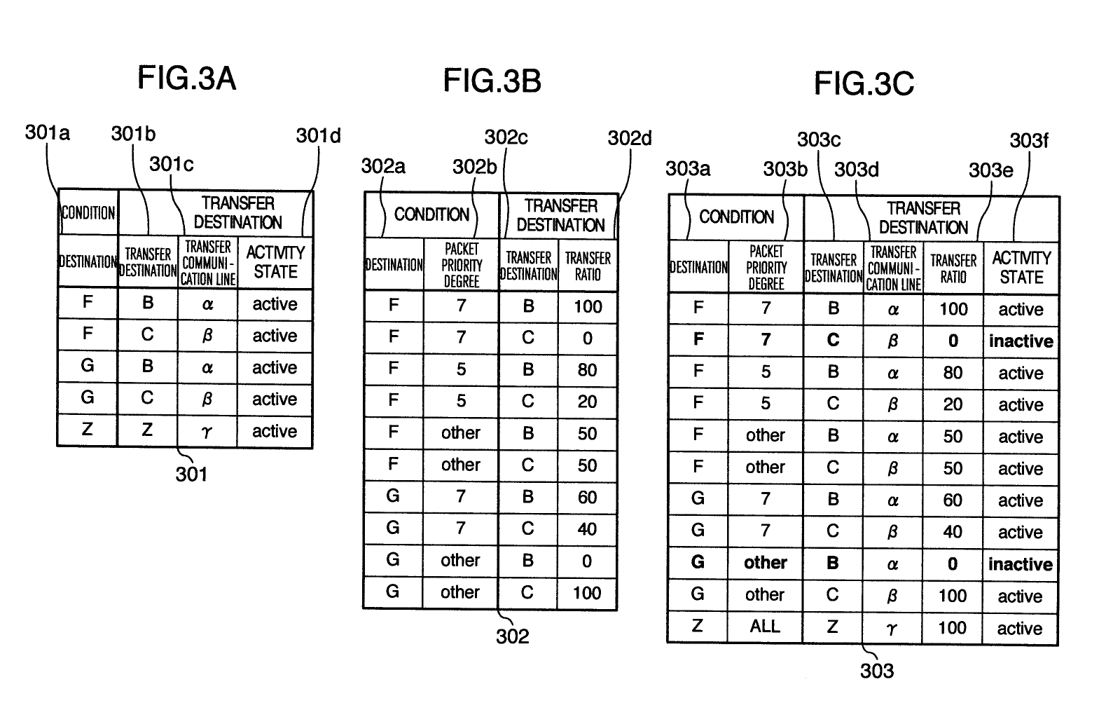

FIGS. 3A to 3C show the structure of packet transfer table 303. First, there will be given an explanation regarding the initial packet transfer table 301 and the transfer destination priority definition table 302 which are assumed for packet transfer table 303.

FIG. 3A is the initial packet transfer table 301 held by the packet transfer device 101 in case the transfer destination priority definition table is not set. The initial packet transfer table 301 is composed of final destinations 301a, transfer destinations 301b, transfer communication lines 301c, and activity states 301d. The final destinations 301a are destinations of packets, the transfer processing being determined by comparing the transmitted and received packet destinations and final destinations 301a.

E.g., in the case where the final destination of the received packet in initial packet transfer table 301 is “F”, the corresponding transfer destinations 301b are “B” and “C” and the transfer communication lines 301c to be used are “α” and “β”, respectively. Since the transfer ratio is not set in initial packet transfer table 301, the transfer ratio set as default is utilized. In the present embodiment, in case there is a plurality of transfer communication lines, it is assumed that transfers are performed evenly, with the default setting. In the case of the present example, packets are transferred over respectively “α” and “β” in the proportion of 50 percent each. The activity states 301d indicate whether the same communication lines are utilized or not. If the transfer ratio is 0 percent, the result is that the state is “inactive” and if the transfer ratio is not 0 percent, the result is that the state is “active”.

FIG. 3B is a transfer destination priority definition table 302 in which the transfer path and the transfer ratio are designated by the network operations administrator or the like, in accordance with the degree of priority of the packet on the basis of the priority policy of the concerned network system. The transfer destination priority definition table 302 is composed of final destinations 302a, PKT (packet) priority degrees 302b, transfer destinations 302c, and transfer ratios 302d. The transfer destination 302a is the transfer destination of a packet, packet degree of priority 302b is the degree of priority of the packet (or a service class, e.g. TOS, is utilized), the transfer processing being determined by the final destination and packet degree of priority of the received packet. The packet degree of priority 302b is a packet degree of priority decided for each service. In the present embodiment, it can be set from 0 to 7, 7 being the highest degree of priority. Also, “other” indicates, for the same destination, values other than those set individually. E.g., in the case of final destination “F”, “other” works out to other values than “7” and “5”. “All” indicates all the degree of priority values.

An exemplification of FIG. 3B will be described. The transfer destinations 302c are “B” and “C” and the transfer ratio 302d to be used would be “100” and “0”, in the case where the final destination of the received packet is “F” and the degree of priority of the packet is “7” in transfer destination priority definition table 302. In the case where the final destination of the received packet is “F” and packet degree of priority 302b is “other”, the transfer destinations 302c are “B” and “C” and the transfer ratios 302d to be used are “50” and “50”.

In FIG. 3C, there is shown the structure of packet transfer table 303. The packet transfer table 303 is generated by the initial packet transfer table 301 and the transfer destination priority definition table 302. The packet transfer table 303 is composed of final destinations 303a, packet (PKT) degrees of priority 303b, transfer destinations 303c, transfer communication lines 303d, transfer ratios 303e, and activity states 303f. The transfer destination, the transfer communication lines, and the transfer ratios are determined by the packet destination and the packet (PKT) degree of priority.

E.g., in the case where the final destination of the transmitted/received packet is “F” and the packet degree of priority is “7” in packet transfer table 303, the transfer destinations 303c are “B” and “C” and the transfer communication lines 303d and the transfer ratios 303e thereof are, respectively, “100” for “α” and “0” for “β”. The activity state 303f is “active” for “α” since the transfer ratio is different from “0”. Since “β” has a transfer ratio of “0” and is not being utilized at all, it is “inactive”.

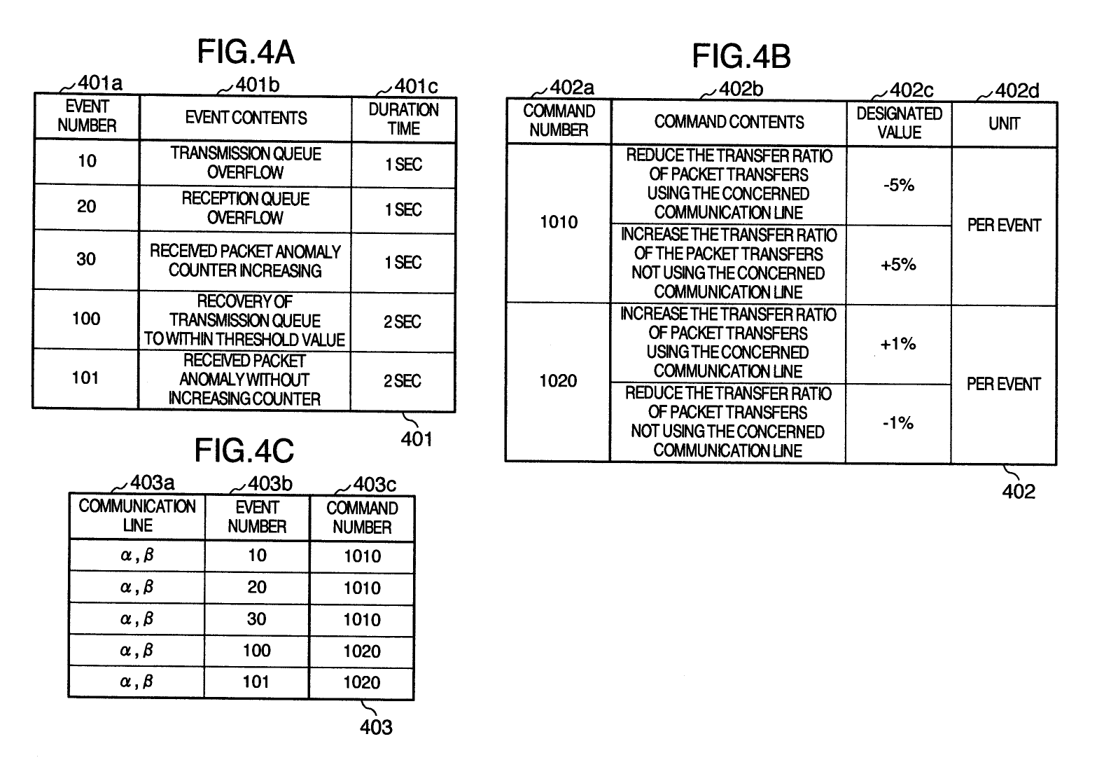

In FIGS. 4A, 4B, and 4C, the structures of an event table 401, an action table 402, and a command table 403 are shown respectively. The event table 401 shown in FIG. 4A is composed of event numbers 401a, event contents 401b, and duration times 401c. The event table 401 is utilized by device control part 201 for the comparison with events inside a monitored packet transfer device 101. In case an event defined in event table 401 occurs, the device control part 201 modifies the contents of packet transfer table 303 utilizing the action table 402 and the command table 403.

Event number 401a is a number identifying the event contents uniquely. As for event contents 401b, the specific content of an event is defined. E.g., “transmission queue overflow” and “reception queue overflow” signify that overflows of the queues for transmission and reception have respectively occurred. “Received packet anomaly counter increase” signifies the case where the number of times packet anomalies have been received is counted and the counter has increased. The duration time 401c is one set to indicate how long the event has lasted before the same event is considered to have occurred.

E.g., in case the transmission queue overflow has continued for 1 second or more in transmitted packet control part 208a, there results that an event corresponding, in event table 401, to a report number 401a of “10”, event contents 401b “Transmission queue overflow” and a duration time of “1 second” has occurred. In other words, device control part 201 compares event table 401 and the event that has occurred and, in the case of matching, judges that an anomaly has occurred in packet control part 208a.

Action table 402 shown in FIG. 4B is composed of command numbers 402a, command contents 402b, designated values 402c, and units 402d. The Command number 402a is a number which uniquely identifies the command contents with respect to the occurring event. The command contents 402b are specific command contents. The designated value 402c is defined to be a specific value utilized in the command content. The unit 402d is defined to indicate how many occurrences of the event a command is given.

E.g., in action table 402, the command contents of command number “1010” are “Reduce the transfer ratio of packet transfers using the concerned communication line” and “Increase the transfer ratio of packet transfers not using the concerned communication line”. Also, the designated value of “Reduce the transfer ratio of packet transfers using the concerned communication line” is “minus 5 percent” and the unit is “for each event”. That is to say that in case an event has occurred once on a certain communication line, it is indicated that the transfer ratio of the concerned communication line is reduced by 5 percent. It is the same regarding the command content “Increase the transfer ratio of packet transfers not using the concerned communication line” as well.

Command table 403 shown in FIG. 4C is composed of communication lines 403a, event numbers 403b, and command numbers 403c. If the occurrence of an event is detected by means of the event table 401, the device control part 201 looks up a command number from the command table 403 by means of the communication line on which the event has occurred and the event number of the occurring event. By means of the retrieved command number, it looks up the command content of the action table 402.

E.g., in the case where a reception queue overflow has occurred in the communication line α transfer processing by packet transfer device 101, it is detected by means of event table 401 that a report number “20” has been generated. Command table 403 looks up the line corresponding to communication line “α” and event number “20”. From the diagram, it can be seen that the second line from the top of command table 403 corresponds. The command number in this case is “1010”. Further, by means of communication line 403a, since “α” is the communication line on which the event has occurred, it can be seen that the other line, “β”, is a communication line on which no event has occurred. Further, instead of the communication line name, there may be stored in communication line 403a the name or ID or the like of the physical communication line interface part connected with the communication line.

Next, the line of action table 402 indicating the corresponding command content is looked up by means of command number “1010”. From the drawing, the processing corresponding to command number “1010” is “Reduce the transfer ratio of packet transfers using the concerned communication line” and “Increase the transfer ratio of packet transfers not using the concerned communication line”. Accordingly, the device control part 201 reduces the transfer ratio of the communication line a packet transfers of and increases the transfer ratio of the communication line P packet transfers. Regarding designated value 402c and unit 402d, these are as described above.

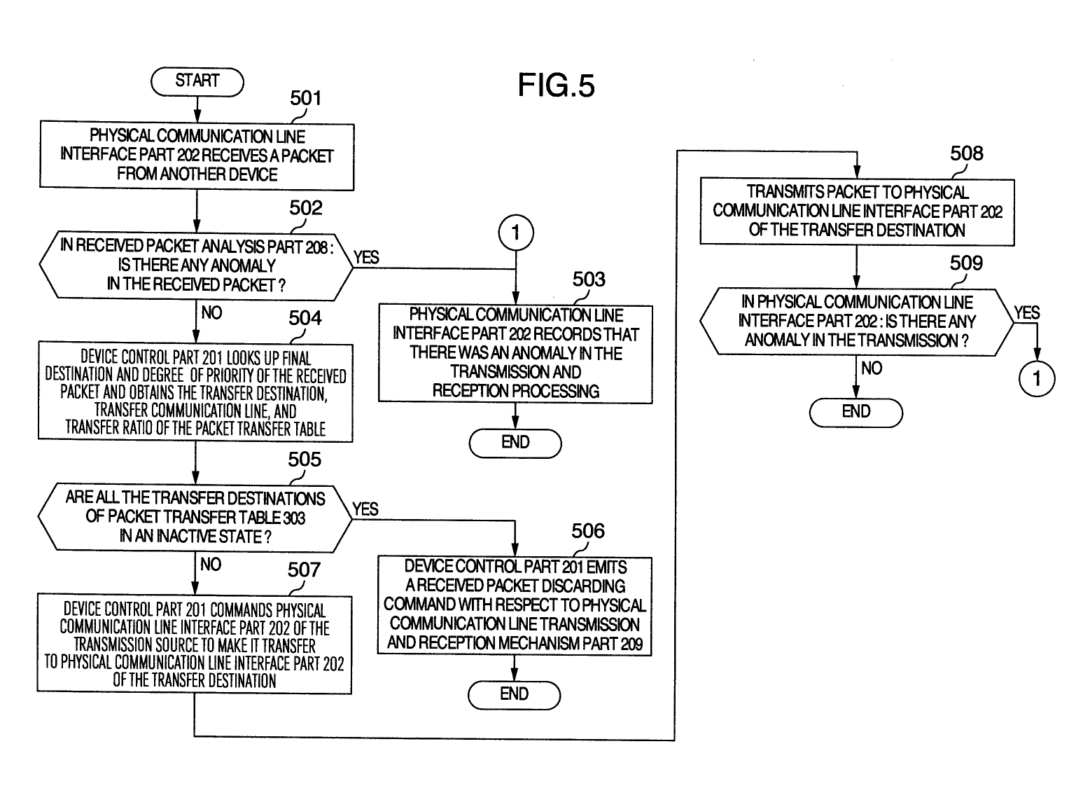

Next, there is shown in FIG. 5 the process flow of packet transfer device 101 on the occasion of receiving a packet. The same flows result for the other packet transfer devices 102 to 105. If the physical communication line interface part 202 receives a packet from another device (Step 501), the received packet analysis part 209 analyzes whether there is an anomaly in the received packet (Step 502). In case the received packet analysis part 209 judges that there is an anomaly in the received packet, the physical communication line interface part 202 records that there has been an anomaly in the transmission and reception processing (Step 503). The record in Step 503 is utilized in event table 401 of FIG. 4A in case the duration time during which the event is occurring continuously is examined. E.g., in case a transmission queue overflow anomaly has been recorded continuously for 1 second or more, it is considered that a failure has occurred. In the case where a packet from terminal 108 and bound for server 106 is received in the received packet analysis part 208c of physical communication line interface part c202c, received packet analysis part 208c examines whether there is no anomaly in the packet received from the terminal 108.

In Step 502, in case received packet analysis part 209 has judged that there is no anomaly in the received packet, device control part 201 looks up the degree of priority of the final destination of the received packet and obtains the transfer destination, transfer communication line, and transfer ratio of the packet transfer table (Step 504). Next, device control part 201 looks up packet transfer table 303 and judges whether all the transfer destinations are inactive (Step 505).

In the case where the transfer destinations are all inactive, the device control part 201 emits a received packet discarding command with respect to received packet analysis part c208c and terminates processing (Step 506). E.g., in the case of transmitting a packet from the terminal 108 and bound for server 106, since the result is that there are no transfer destinations present in case both packet transfer device 102 and packet transfer device 103, being transfer destinations, are inactive, the device control part 201 emits a received packet discarding command with respect to the received packet analysis part c208c.

In the case where even one transfer destination is active, e.g. the device control part 201 gives a command to select a physical communication line interface part 202 of the transmission source corresponding to a physical communication line interface part 202 of the transfer destination to transfer packets by looking up a storage part which stores communication lines to which communication line each physical communication line interface part 202 corresponds (Step 507). E.g., in the case of transmitting a packet from terminal 108 and bound for server 106, physical communication line interface part a202a and physical communication line interface part b202b correspond to the physical communication line interface part 202 of the transfer destination. If device control part 201 selects physical communication line interface part a202a and physical communication line interface part b202b, a command is given to received packet analysis part c208c of physical communication line interface part c202c to, in accordance with the transfer ratio, transfer the packet to physical communication line interface part a202a and physical communication line interface part b202b.

Physical communication line interface part 202 of the transmission source transmits the packet to the physical communication line interface part 202 of the transfer destination (Step 508). In physical communication line interface part 202, it is judged whether there is an anomaly in the transmission (Step 509). In Step 509, transmission queue overflows and the like are monitored. In case there is an anomaly, the processing transits to Step 503. In case there is no anomaly, the processing is terminated.

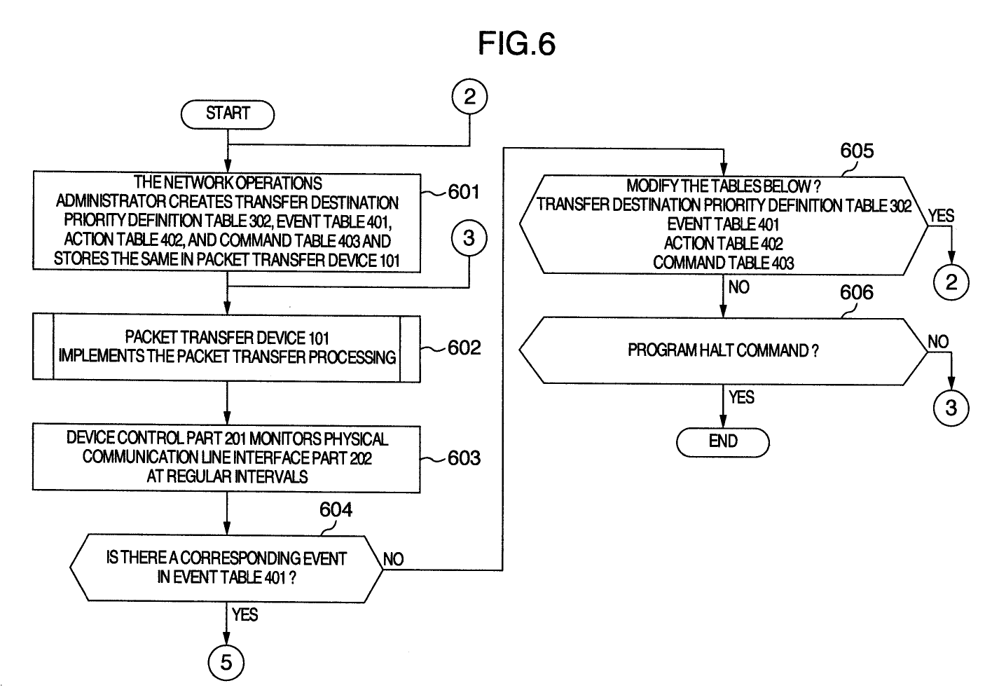

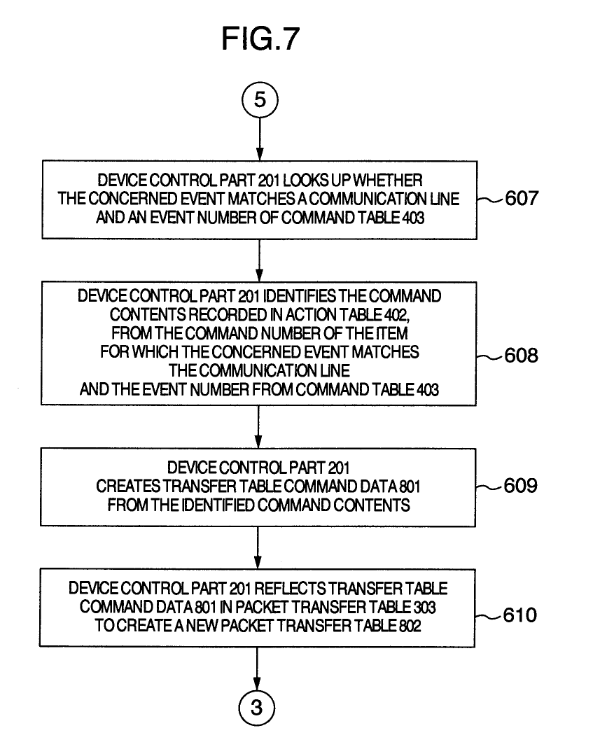

In FIG. 6 and FIG. 7, the processing flow of the packet monitoring of packet transfer device 101 is shown. The same flow results regarding the other packet transfer devices 102 to 105. First, transfer destination priority definition table 302, event table 401, action table 402, and command table 403 are defined in advance by the network operations administrator or the like (Step 601). Next, packet transfer device 101 implements (Step 602) the packet transfer processing (packet transmission and reception). And then, device control part 201, on the occasion of transmitting and receiving the packet in Step 602, monitors physical communication line interface part 202 at regular intervals (Step 603).

In the monitoring in Step 603, device control part 201 monitors whether, in physical communication line interface part 202, a received packet anomaly has been detected or the transmission queue has overflowed or the reception queue has overflowed. Also, in case the transmission queue or the reception queue has overflowed, it is monitored whether the data accumulated in the transmission queue or the reception queue have recovered to within a threshold value. Further, in case an anomaly has occurred in the received packet, it is monitored whether there have been a recovery from the anomaly.

Next, device control part 201 judges, by means of the monitoring in Step 603, whether an event corresponding to event table 401 has been detected In Step 604, in case an event corresponding to event table 401 has not occurred, modifications in transfer destination priority definition table 302, event table 401, action table 402, or command table 403 are received by means of user input or the like (Step 605). In Step 605, even in case there occurs no event found in command table 403, the network operations manager or the like receives input, in a case such as carrying out a redefinition or the like of a table on the basis of a change in the network policy.

In case there has been a table change input in Step 605, a transition is made to Step 601. In case there has been no table change input in Step 605, it is checked whether there is a command to halt the program (Step 606). The command to halt the program is input by the network operations administrator or the like. In case there has been no command to halt the program in Step 606, a transition is made to Step 602. In case there has been a command to halt the program in Step 606, the program processing of device control part 201 is halted.

In the case where an event corresponding to event table 401 has occurred in Step 604, device control part 201 looks up whether a combination of the event number obtained in Step 604 and the communication line on which the event has happened is stored in command table 403 (Step 607). Device control part 201 identifies the command contents recorded in action table 402 from the command number of the item (record), of command table 403, corresponding to the communication line and event number for the event that has occurred (Step 608). Next, device control part 201 generates transfer table command data 801 from the identified command contents (Step 609). Regarding transfer table command data 801, a description will be given subsequently. Device control part 201 reflects the contents of transfer table command data 801 in packet transfer table 303 to create a new packet transfer table 802 (Step 610). After the processing of Step 610, a transition is made to Step 602.

The processing from Step 601 and up to Step 610 in FIG. 6 and FIG. 7 will be explained using an exemplification. In Step 601, the network operations administrator sets the contents of FIG. 3B in transfer destination priority definition table 302. Further, the network operations administrator sets the contents of FIGS. 4A, 4B, and 4C respectively in event table 401, action table 402, and command table 403. Device control part 201 generates packet transfer table 303 of FIG. 3C from the input contents of transfer destination priority definition table 302 and the pre-set initial packet transfer table 301.

Next, in Step 602, packet transfer device 101 implements packet transfer processing by means of physical communication line interface part a202a, physical communication line interface part b202b, and physical communication line interface part c202c. In Step 603, device control part 201 monitors physical communication line interface part a202a, physical communication line interface part b202b, and physical communication line interface part c202c.

Here, in case “reception queue overflow” occurs when physical communication line interface part a202a receives a packet from communication line “α”, device control part 201 obtains the event number from event table 401 of FIG. 4A in Step 604. In the event number 401a of event table 401, the event number is looked up in the cell of the line where event contents 401b are “reception queue overflow”. Since, from the diagram, the event number of “reception queue overflow” is “20” and there exists a corresponding event, a transition is made to Step 607.

In Step 607, device control part 201 looks up the line where communication line 403a includes “α” and event number 403b is the number “20” obtained in Step 604. From the diagram, it can be seen that the communication line and the event number match since the second line from the top of command table 403 has communication lines “α” and “β” and event number “20”.

In Step 608, device control part 201 extracts command number “1010” from command table 403 in the line for which the communication lines are “α” and “β” and the event number is “20” (the second line from the top). On the basis of the concerned command number “1010”, the command contents recorded in action table 402 are identified. It can be seen from FIG. 4B that the command contents are “Reduce the transfer ratio of packet transfers using the concerned communication line” and “Increase the transfer ratio of packet transfers not using the concerned communication line”.

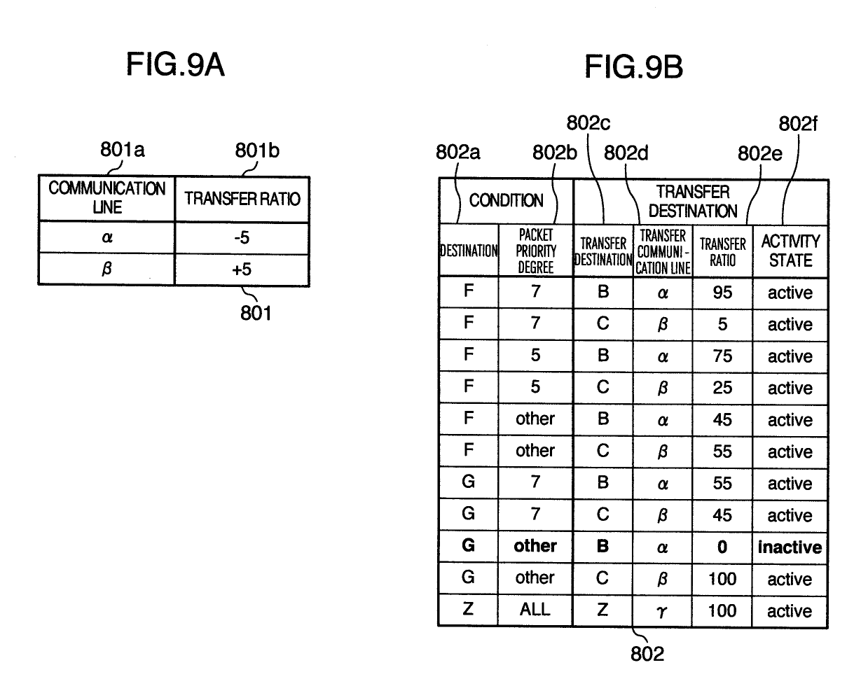

In Step 609, device control part 201 creates command table 801 of FIG. 9A from the identified command contents “Reduce the transfer ratio of packet transfers using the concerned communication line” and “Increase the transfer ratio of packet transfers not using the concerned communication line”. Specifically, it looks up the line of command number “1010” of action table 402 to see a need to reduce, by the designated value corresponding to “minus 5 percent”, the transfer ratio of packet transfers on communication line “α” on which the event “reception queue overflow” has occurred. Also, there is a need to increase, by the designated value corresponding to “plus 5 percent”, the transfer ratio of packet transfers on communication line “b” on which the event “reception queue overflow” has not occurred.

Accordingly, device control part 201 creates the transfer table command data 801 shown in FIG. 9A. Transfer table command data 801 constitute a table in which commands for modifying packet transfer table 303 are stored. Transfer table command data 801 are composed of communication lines 801a and transfer ratios 801b. The communication line 801a gives the indication “Reduce by 5 percent” for the transfer ratio of communication line “α” and the indication “Increase by 5 percent” for the transfer ratio of communication line “β”.

In Step 610, device control part 201 reflects the contents of transfer table command data 801 in packet transfer table 303. In FIG. 9B, a new packet transfer table 802 is shown. The new packet transfer table 802 is composed of final destinations 802a, packet priority degrees 802b, transfer destinations 802c, transfer communication lines 802d, transfer ratios 802e, and activity states 802f. If the transfer ratios 802e of new packet transfer table 802 is compared with the transfer ratios 303e of packet transfer table 303, it can be seen that the transfer ratio of communication line “α” is given by “Reduced by 5 percent”. Also, it can be seen that the transfer ratio of communication line “β” is given by “Increased by 5 percent”.

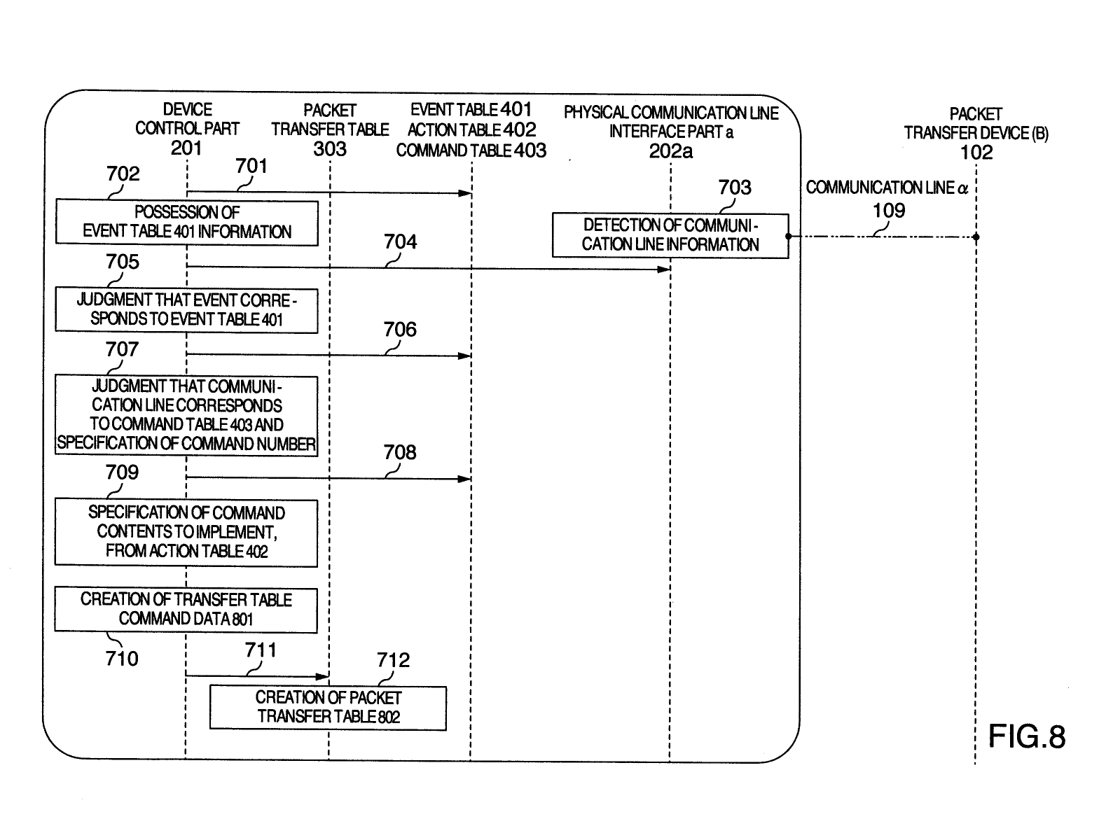

In FIG. 8, there is shown a sequence between each of the functional parts on the occasion of detecting a transmission and reception anomaly inside packet transfer device 101 described above. Device control part 201 acquires the contents of event table 401 (Steps 701 and 702). Next, physical communication line interface part a202a detects communication line information such as “Received packet anomaly” or “Reception queue overflow” when carrying out packet transmission and reception via communication line “α” (Step 703). Further, physical communication line interface part b202b and physical communication line interface part c202c carry out similar processing.

Next, device control part 201 acquires communication line information (Step 704) at regular intervals from physical communication line interface part a202a and judges (Step 705) whether the concerned acquired communication line information is an event corresponding to an event defined in event table 401. Next, if the aforementioned communication line information is judged in Step 705 to correspond to an event defined in event table 401, device control part 201 looks up command table 403 (Step 706) and identifies a communication line and a command number corresponding to command table 403 (Step 707).

Next, device control part 201 looks up action table 402 (Step 708) and identifies, from action table 402, the command contents to be implemented (Step 709). Device control part 201 creates transfer table command data 801 on the basis of the command contents identified in Step 709 (Step 710). Device control part 201 looks up packet transfer table 303 (Step 711) and creates a new packet transfer table 802 from the aforementioned created transfer table command data 801 (Step 712).

According to the contents of the aforementioned embodiment, there results a flexible packet transfer processing function using a plurality of paths, on the basis of the data class and the communication line quality. Also, by monitoring the state of the communication lines, it is possible to flexibly set the transfer ratio in response to the state of the communication lines.

Further, in the present embodiment, the physical communication line interface part is an interface carrying out communication processing and may simply be expressed as an interface part. In addition, the packet transfer table is a table utilized for carrying out packet routing and may be expressed as a routing table. The device control part may simply be expressed as a control part.

It should be further understood by those skilled in the art that although the foregoing description has been made on embodiments of the invention, the invention is not limited thereto and various changes and modifications may be made without departing from the spirit of the invention and the scope of the appended claims.

1. A packet transfer device connected with network equipment and transferring packets, comprising:
a plurality of interface parts which carry out the transmission and reception of packets; and
a control part which monitors the plurality of interface parts and controls the packet transfer device,
wherein a first interface part of the plurality of interface parts and a second interface part of the plurality of interface parts transmits and receives the packets to and from the network equipment; and
wherein the control part, when there is an anomaly in the transmission and reception of the packets in the first interface part, reduces a packet transfer ratio of the first interface part and increases the packet transfer ratio of the second interface part.

2. The packet transfer device according to claim 1, further comprising a routing table for setting service classes of the transmitted and received packets, the transfer destination network equipment utilized in the transfer of the packets for each final destination, and the transfer ratios to the transfer destination network equipment, and
wherein the control part looks up the routing table to carry out packet transfer processing.

3. The packet transfer device according to claim 2,
wherein the control part: reduces the transfer ratio, of the routing table, to the transfer destination network equipment which is connected with the first interface part and increases the transfer ratio, of the routing table, to the transfer destination network equipment connected with the second interface part.

4. The packet transfer device according to claim 1, further comprising an event table which defines events monitored with the interface part, and
wherein the control part compares an event detected by the first interface part and the events defined in the event table and, if there is a match, judges that there is an anomaly in the transfer destination network equipment connected with the first interface part or in the communication line between the first interface part and the transfer destination network equipment.

5. The packet transfer device according to claim 4, further comprising an action table which stores events monitored by the interface part and routing table update contents corresponding to the events, and
wherein the control part extracts, from the routing table, the event detected by the interface part and the corresponding update contents and the control part updates the routing table on the basis of the extracted update contents.

6. The packet transfer device according to claim 5, further comprising a command table which includes the interface parts, events monitored by the interface parts, and identifiers uniquely identifying the routing table update contents corresponding to the events, and wherein:
in case there is an anomaly in the transfer destination network equipment connected with the first interface part or in the communication line between the first interface part and the transfer destination network equipment,
the control part looks up the command table and extracts the routing table update contents corresponding to the first interface part and the event detected by the first interface part; and
the control part, based on the extracted update contents, updates the transfer ratio, of the routing table, to the transfer destination network equipment connected with the first interface part.

7. The packet transfer device according to claim 1, wherein the control part monitors whether there is an anomaly or not in the packet received by the first interface part.

8. The packet transfer device according to claim 1, wherein the control part monitors whether reception queue overflow has occurred in the first interface part.

9. The packet transfer device according to claim 1, wherein the control part monitors whether transmission queue overflow has occurred in the first interface part.

10. A communication method associated with a packet transfer device having a plurality of interface parts connected with network equipment and transferring packets, comprising the steps of:
transmitting and receiving packets to and from the network equipment by means of a first interface part of the plurality of interface parts and a second interface part of the plurality of interface parts; and,
in case there is an anomaly in the transmission and reception of packets in the first interface part:
monitoring the transmission and reception of packets in the first interface part;
reducing the packet transfer ratio of the first interface part; and
increasing the packet transfer ratio of the second interface part.

11. The communication method according to claim 10, further comprising the steps of:
setting, in a routing table, the service classes of transmitted and received packets, the transfer destination network equipment utilized in the transfer of the packets for each final destination, and the transfer ratios to the transfer destination network equipment; and
looking up the routing table to transfer the packets.

12. The communication method according to claim 11, further comprising the steps of:
reducing the transfer ratio, of the routing table, to the transfer destination network equipment which is connected with the first interface part; and
increasing the transfer ratio, of the routing table, to the transfer destination network equipment connected with the second interface part.

13. The communication method according to claim 10, further comprising the steps of:
setting events monitored with the interface part in an event table; and
comparing an event detected by the first interface part and the events defined in the event table and, if there is a match, judging that there is an anomaly in the transfer destination network equipment connected with the first interface part or in the communication line between the first interface part and the transfer destination network equipment.

14. The communication method according to claim 13, further comprising the steps of:
setting, in an action table, events monitored by the interface part and routing table update contents corresponding to the events;
extracting, from the routing table, the event detected by the interface part and the corresponding update contents; and
updating the routing table on the basis of the extracted update contents.

15. The communication method according to claim 14, further comprising the steps of:
in case there is an anomaly in the transfer destination network equipment connected with the first interface part or in the communication line between the first interface part and the transfer destination network equipment:
defining a command table including the interface parts, events monitored by the interface parts, and identifiers uniquely identifying the routing table update contents corresponding to the events;
looking up the command table and extracting the routing table update contents corresponding to the first interface part and the event detected by the first interface part; and
updating, on the basis of the extracted update contents, the transfer ratio, of the routing table, to the transfer destination network equipment connected with the first interface part.

16. The communication method according to claim 10, further comprising the step of monitoring whether there is an anomaly or not in the packet received by the first interface part.

17. The communication method according to claim 10, further comprising the step of monitoring whether reception queue overflow has occurred in the first interface part.

18. The communication method according to claim 10, further comprising the step of monitoring whether transmission queue overflow has occurred in the first interface part.
